(19) United States
(12) Patent Application Publication
(10) Pub. No.: US 2017/0323090 A1
(43) Pub. Date: Nov. 9, 2017

(54) Dynamic Authentication Method

(71) Applicant: SOLUS PS SDN BHD, Kuala Lumpur (MY)

(72) Inventor: MATTHEW ROBERT AINSCOW, Bangkok (TH)

(21) Appl. No.: 15/469,576

(22) Filed: Mar. 27, 2017

(30) Foreign Application Priority Data
May 5, 2016 (MY) UI 2016701618

(51) Int. Cl. G06F 21/31

(52) U.S. Cl. CPC G06F 21/31

(57) ABSTRACT

The present invention provides a dynamic authentication method (200), comprising the steps of displaying (210) a plurality of keys (103) on a screen (104) of a computing device (102) in a random order, receiving (220) a password having a predetermined number of characters entered using a pointing device (110), hashing (240) the password to obtain a hash value and performing (250) at least one of storing the hash value at a memory (106) provided within the computing device (102) and transmitting the hash value to a database (112). Further, the random order is shuffled on receiving each character from the predetermined number of characters. Also, the plurality of keys (103) is erased from the screen (104) when a character from the predetermined number of characters is not received for a predetermined period of time.

### CROSS-REFERENCE OF RELATED PATENT APPLICATION:

The present application claims priority under the Paris Convention to the Malaysia utility innovation application no. PI 2016701618 filed on May 5, 2016; the disclosure of which is incorporated herein by reference in its entirety.

### TECHNICAL FIELD

Embodiments of the present invention relate to user authentication systems and methods and more particularly, to a dynamic authentication method.

### BACKGROUND

Enrollment and authentication are important steps for granting access to a user while accessing a web based service, in order to prevent any malicious activities. A common method for enrollment and authentication involves entering of a password with a predetermined number of characters. The predetermined number of characters may be alphanumeric or may include a plurality of special characters.

Typically, the password is entered using a keyboard provided at a computing device. However, entering a password using a keyboard is prone to a plurality of security risks. A person attempting to gain an unauthorized access to the web based service may be able to obtain the password just by reading the position of fingers of the user while user enters the password. Alternately, an intervening device may be attached to the computing device, which is capable of keystroke logging.

There have been a number of solutions provided for secure authentication of a user and one of them has been discussed below:

U.S. Pat. No. 7,849,301 B2 discloses a system and a method for allowing a secure access to a computing device using an on-screen keyboard. A user is expected to enter a predetermined password using a pointing device. On successful authentication, the user is allowed access to the computing device.

US20120323788A1 talks about a method for authenticating debit card transactions engaged in by a cardholder on a communications network. The method includes establishing a network connection with a client being used by the cardholder to engage in a transaction; providing to the client a web page containing a keypad of buttons that collectively define a geometry of the keypad, the keypad being employed by the cardholder to enter a PIN via selection of the buttons with a pointing device; obtaining the PIN enter by the cardholder; determining if the PIN is correct for a debit card being used by the cardholder; and for two transactions engaged in by the cardholder, changing a location of the keypad on the web page, the geometry of the keypad, a size of the buttons or a spacing between neighboring buttons.

The aforesaid documents and other solutions may strive to provide secure systems and methods for authentication of a user. However they still have a number of shortcomings and limitations such as, but not limited to, being static in nature. The on-screen keyboard generates a plurality of static locations for a plurality of keys. The plurality of static locations may be easily obtained and the password entered by the pointing device may be accessed using a spyware program installed in the computing device. Such spyware programs may be stealthily installed into the computing device, while the computing device is connected to cyber space. Further, the spyware program may be able to access the password stored at the computing device.

Accordingly, there remains a need in the prior art to have a method for authentication of a user which overcomes the aforesaid problems and shortcomings.

However, there remains a need in the art for a dynamic authentication method which is immune to cyber threats.

### SUMMARY OF THE INVENTION

Embodiments of the present invention aim to provide a dynamic authentication method. The method enables users to carry out transactions without any fear of security risks.

Embodiments of the present invention are made possible in this way:

A dynamic authentication method comprising the steps of displaying a plurality of keys on a screen of a computing device in a random order, receiving a password having a predetermined number of characters entered using a pointing device, hashing the password to obtain a hash value and performing at least one of storing the hash value at a memory provided within the computing device and transmitting the hash value to a database. Further, the random order is shuffled on receiving each character from the predetermined number of characters. Also, the plurality of keys is erased from the screen when a character from the predetermined number of characters is not received for a predetermined period of time.

As compared to conventional authentication methods, the advantages of the present invention are:

First, the present invention is dynamic in nature, i.e., the random order of the plurality of keys, as per the present invention is shuffled intuitively, whereas the systems and methods in the art are static. The dynamic nature of the present invention makes it more secure to a plurality of cyber threats. Further, after a password has been obtained, it is hashed before it is stored in the memory or transmitted to the database. The hashing of the password ensures that it does not get stolen while transmission, or when the device is wrongfully obtained by an unauthorized user.

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawing illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates a top level diagram of a dynamic authentication system in accordance with an embodiment of the present invention.

FIG. 2 is a flow chart illustrating a dynamic authentication method in accordance with an embodiment of the present invention.

FIG. 3 illustrates a screen of the dynamic authentication system in accordance with an exemplary embodiment of the present invention.

### DETAILED DESCRIPTION OF THE INVENTION

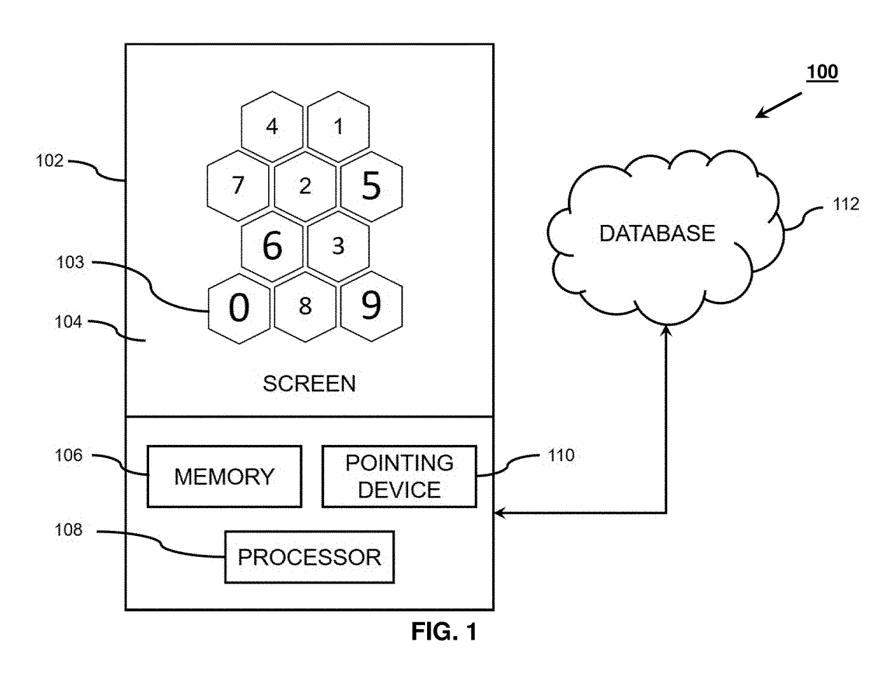

Referring to the drawings, the invention will now be described in more detail. In accordance with an embodiment of the present invention, a dynamic authentication system (100), as shown in FIG. 1, comprises a computing device (102) having a screen (104), a memory (106), a processor (108) and a pointing device (110). Further, the computing device (102) is connected to a database (112).

In accordance with an embodiment of the present invention, the computing device (102) is, but not limited to, a personal computer, a mobile phone, a tablet and a personal digital assistant.

In accordance with an embodiment of the present invention, the screen (104) is, but not limited to, an LCD screen, an LED screen or any other display device.

In accordance with an embodiment of the present invention, the pointing device (110) is, but not limited to, a mouse, a touchpad, a touch screen and a stylus.

In accordance with an embodiment of the present invention, the memory (106) is one of, but not limited to, a non-volatile memory such as EPROM, EEPROM, flash memory and any other storage medium.

In accordance with an embodiment of the present invention, the memory (106) stores a plurality of instructions. On execution of the plurality of instructions, the processor (108) is configured to display a plurality of keys (103) on the screen (104) of the computing device (102).

In accordance with an embodiment of the present invention, the plurality of keys (103) is displayed on the screen (104) as an image map. The plurality of keys (103) is assigned a set of a plurality of respective regions on the screen (104). The x-y coordinates of the plurality of regions defining the plurality of respective keys (103) is stored in the memory (106). The capacitive touch acts as the pointing device (110).

Further, the processor (108) is configured to receive a password having a predetermined number of characters. The predetermined number of characters is, but not limited to, alphanumeric characters. Further, the predetermined number of characters comprises special characters. The predetermined number of characters is entered using the capacitive touch. When a user selects a specific area of the screen (104) with the pointing device (110), the x-y coordinates of the specific area are compared with the x-y coordinates of the plurality of regions defining the plurality of respective keys (103) to determine a character entered by the user. Further, the processor (108) is configured to shuffle the random order on receiving each character from the predetermined number of characters, i.e., the plurality of keys (103) is assigned a new set of the plurality of respective regions. The process is repeated after receiving of each character from the predetermined number of characters.

In accordance with an embodiment of the present invention, the processor (108) is configured to hash the password to obtain a hash value. In accordance with an embodiment, the password has between four and nine characters. The number of characters in a password is determined by a developer or the user. The password is extrapolated by the processor (108) into the hash value using a salt and a hashing algorithm. The salt is added to the password to obtain a resultant string. The resultant string is then hashed using the hashing algorithm. The hashing algorithm is one of, but not limited to, MD5 or SHA etc. Alternately, the hashing algorithm is defined by the developer. In accordance with an embodiment, the hash has a length of fifty characters.

In accordance with an embodiment of the present invention, the processor (108) is configured to perform at least one of storing the hash value at the memory (106) and transmitting the hash value to the database (112) as per the configuration of the system (100) set by the developer.

For transmitting the hash value to the database (112), the processor (108) is configured to confirm a connection between the computing device (102) and the database (112). In accordance with an embodiment of the present invention, the computing device (102) is connected to the database (112) over the internet. Alternately, the computing device (102) is connected to the database (112) through, but not limited to, LAN, WAN or Wi-Fi etc. On confirmation of the connection between the database (112) and the computing device (102), the hash value is transmitted to the database (112). Alternately, if the database (112) is not connected with the computing device (102), the hash value is stored at the memory (106) until a connection between the database (112) and the computing device (102) is established.

In accordance with an embodiment of the present invention, the processor (108) is further, configured to erase the plurality of keys (103) from the screen (104), when a character from the predetermined number of characters is not received for a predetermined period of time.

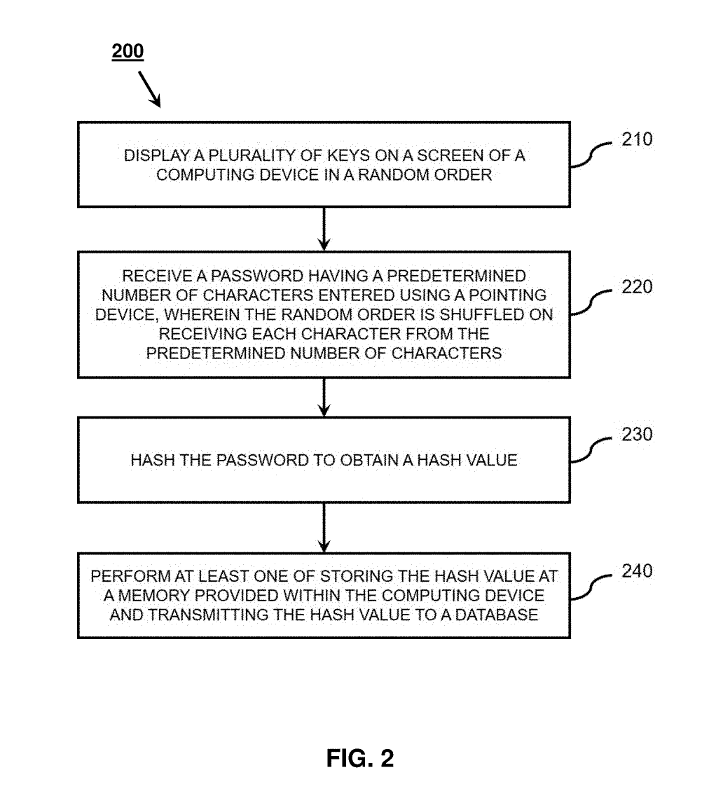

As shown in FIG. 2, a dynamic authentication method (200) for secure entry of a password is illustrated. The method begins at step 210, by displaying the plurality of keys (103) on the screen (104) of the computing device (102) in a random order. The plurality of keys (103) is displayed in form of, but not limited to, a dial or a tree structure.

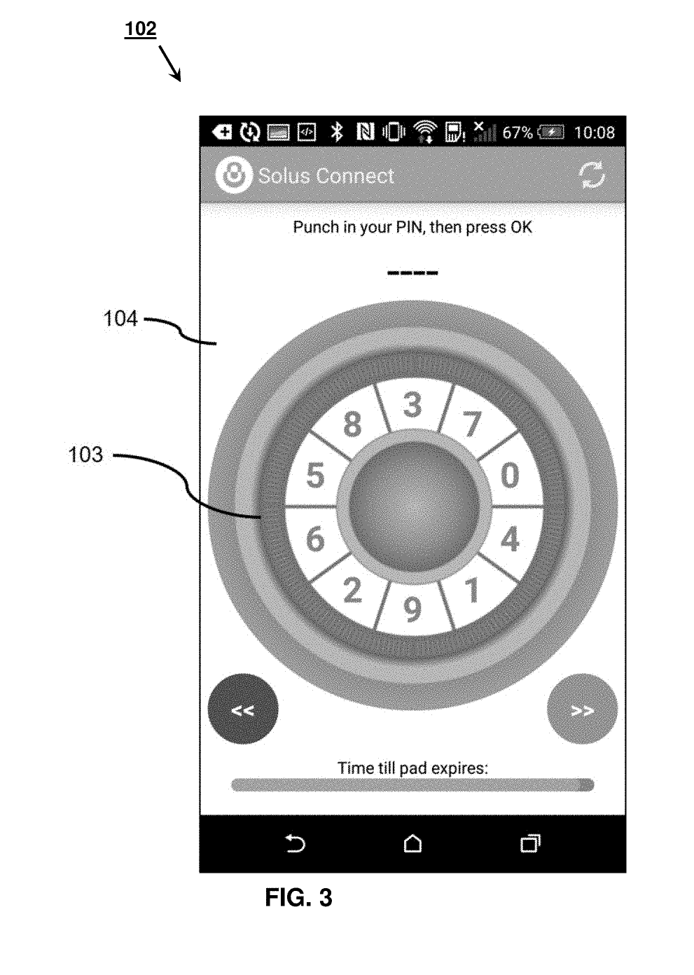

FIG. 3 illustrates the plurality of keys (103) displayed on the screen (104) of the computing device (102) in accordance with an exemplary embodiment of the present invention. As shown in FIG. 3, the plurality of keys (103) has been displayed in a form of a dial.

In accordance with an embodiment of the present invention, the plurality of keys (103) is displayed on the screen (104) as an image map. The plurality of keys (103) is assigned a set of a plurality of respective regions on the screen (104). The x-y coordinates of the plurality of regions defining the plurality of respective keys (103) are stored in the memory (106).

At step 220, a password having a predetermined number of characters is received. The password is entered using the pointing device (110). Further, the random order is shuffled on receiving each character from the predetermined number of characters.

In accordance with an embodiment of the present invention, a user selects a specific area of the screen (104) with a capacitive touch acting as the pointing device (110). The x-y coordinates of the specific area are compared with the x-y coordinates of the plurality of regions defining the plurality of respective keys (103) to determine a character entered by the user. Further, on receiving each character from the predetermined number of characters the plurality of keys (103) is assigned a new set of the plurality of respective regions. The process is repeated after receiving of each character from the predetermined number of characters.

In accordance with an embodiment of the present invention, the plurality of keys (103) is erased from the screen (104) when a character from the predetermined number of characters is not received for a predetermined period of time.

At step 230, the password is hashed to obtain a hash value. The password is extrapolated by the processor (108) into the hash value using a salt and a hashing algorithm. The salt is added to the password to obtain a resultant string. The resultant string is then hashed using the hashing algorithm. The hashing algorithm is one of, but not limited to, MD5 or SHA etc. Alternately, the hashing algorithm is defined by the developer. In accordance with an embodiment, the hash value has a length of fifty characters.

At step 240, at least one of storing the hash value at the memory (106) provided within the computing device (102) and transmitting the hash value to the database (112) is performed as per the configuration of the method (200) set by the developer.

When the method (200) is configured to transmit the hash value to the database (112), a connection between the computing device (102) and the database (112) is confirmed. In accordance with an embodiment of the present invention, the computing device (102) is connected to the database (112) over the internet. Alternately, the computing device (102) is connected to the database (112) through, but not limited to, LAN, WAN or Wi-Fi etc. On confirmation of the connection between the database (112) and the computing device (102), the hash value is transmitted to the database (112). Alternately, if the database (112) is not connected with the computing device (102), the hash value is stored at the memory (106) until a connection between the database (112) and the computing device (102) is established.

During the enrollment of the user, the hash value is stored at least one of the memory (106) and the database (112) as a reference value. Whereas, during the authentication of the user, the hash value is compared with the reference value to authenticate the user.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claim.

1. A dynamic authentication method (200), comprising the steps of:
defining a plurality of regions on a screen (104) of a computing device (102), each of said plurality of regions having its respective x-y coordinates corresponding to a location on said screen (104);
assigning under a random order each of a plurality of keys (103) to each of said plurality of regions;
displaying (210) said plurality of keys (103) on said screen (104) according to the region assignment of each of said plurality of keys (103);
receiving (220) a password having a predetermined number of characters entered using a pointing device (110);
re-assigning under a reshuffled random order each of said plurality of keys (103) to each of said plurality of regions after each of said password characters is entered;
displaying (210) said plurality of keys (103) on said screen (104) according to the region re-assignment of each of said plurality of keys (103);
wherein said password is entered by selecting a specific area of said screen (104) with said pointing device (110) and comparing said x-y coordinates of said selected specific area with said x-y coordinates in respective to said plurality of regions assigned with said plurality of respective keys (103) to determine a character entered; and
wherein said plurality of regions forms a dial wheel.

2. The method of claim 1, further comprising:
erasing said plurality of keys (103) from said screen (104) when a character from said predetermined number of characters is not received for a predetermined period of time.

3. The method of claim 1, further comprising:
hashing (240) said password to obtain a hash value; and
performing (250) at least one of storing said hash value at a memory (106) provided within said computing device (102) and transmitting said hash value to a database (112);
wherein the hash value is stored at said memory (106) until a connection between said database (112) and said computing device (102) is established and transmitted to said database (112) on confirmation of the connection between said database (112) and said computing device (102).

4. A dynamic authentication method (200), comprising the steps of:
defining a plurality of regions on a screen (104) of a computing device (102), each of said plurality of regions having its respective x-y coordinates corresponding to a location on said screen (104);
assigning under a random order each of a plurality of keys (103) to each of said plurality of regions;
displaying (210) said plurality of keys (103) on said screen (104) according to the region assignment of each of said plurality of keys (103);
receiving (220) a password having a predetermined number of characters entered using a pointing device (110);
re-assigning under a reshuffled random order each of said plurality of keys (103) to each of said plurality of regions after each of said password characters is entered;
displaying (210) said plurality of keys (103) on said screen (104) according to the region re-assignment of each of said plurality of keys (103);
wherein said password is entered by selecting a specific area of said screen (104) with said pointing device (110) and comparing said x-y coordinates of said selected specific area with said x-y coordinates in respective to said plurality of regions assigned with said plurality of respective keys (103) to determine a character entered; and
wherein said plurality of regions forms a tree structure.

5. The method of claim 4, further comprising:
erasing said plurality of keys (103) from said screen (104) when a character from said predetermined number of characters is not received for a predetermined period of time.

6. The method of claim 4, further comprising:
hashing (240) said password to obtain a hash value; and
performing (250) at least one of storing said hash value at a memory (106) provided within said computing device (102) and transmitting said hash value to a database (112);
wherein the hash value is stored at said memory (106) until a connection between said database (112) and said computing device (102) is established and transmitted to said database (112) on confirmation of the connection between said database (112) and said computing device (102).
